(19) United States
(12) Patent Application Publication
(10) Pub. No.: US 2014/0106659 A1
(43) Pub. Date: Apr. 17, 2014

(54) COMPARTMENT AIR COOLING SYSTEM

(71) Applicant: CATERPILLAR INC., Peoria, IL (US)

(72) Inventors: Haiping Hong, Peoria, IL (US); Chris Scolton, Edelstein, IL (US)

(73) Assignee: Caterpillar Inc., Peoria, IL (US)

(21) Appl. No.: 13/649,752

(22) Filed: Oct. 11, 2012

(51) Int. Cl. F24F 7/00; B60H 1/26

(52) U.S. Cl. 454/162; 454/237

(57) ABSTRACT

A compartment cooling system includes a housing defining a substantially enclosed compartment, a flow of heated gas, a nozzle, and multiple tabs. The housing has an air inlet and an air outlet stack defining a flow path. The nozzle directs the flow of heated gas substantially in the flow path direction. The nozzle has an outlet end with a predefined shape. The multiple tabs are adjacent to and spaced about the outlet end. Each tab has a side adjacent the outlet end, and at least three sides in the flow of heated gas. The sides in the flow of heated gas form at least two corners.

### TECHNICAL FIELD

The present disclosure relates generally to air cooling systems. Specifically, an embodiment of the present invention relates to air cooling system for a compartment.

### BACKGROUND

Work machines, for example wheel loaders, generally require relatively high power levels to perform desired work on a worksite. To achieve these high power levels, engines in the machines often operate at relatively high engine and exhaust system temperatures. Engine exhaust aftertreatment equipment, to meet stricter emissions regulation compliance, often reduces the available space. Thus, airflow essential in cooling is reduced. Most of these machines are also subject to noise regulations in many regions of the world. Enclosing the engine in a compartment, reducing openings to the compartment, and adding larger mufflers are methods that have been used to meet these acoustic emission requirements. The combination of increased engine and exhaust temperatures, placing the engine in an enclosed compartment with fewer openings, and reducing the airflow in the compartment present substantial cooling challenges.

The paper “A High Performance, Low Back Pressure Jet Ejector” presented by John F. Foss (Mechanical Engineering Department, Michigan State University, East Lansing, Mich., USA) and Alan R. Lawrenz (Mechanical Engineering Department, Michigan State University, East Lansing, Mich., USA) at the proceedings of the 2011 ASME-JSME-KSME Joint Fluids Engineering Conference held Jul. 24-29, 2011 in Hamamatsu, Shizuoka, Japan, proposes enhanced mixing, with the attendant transfer of momentum between a high speed jet and its surrounding fluid, can be created by the use of triangularly-shaped tabs in conjunction with a tapered exhaust stack. The basic physics of the primary tab flow is to create a “pressure hill” on the bounding surface of the primary conduit. Since vorticity is introduced into a flow at a physical surface in the presence of a surface pressure gradient (as if the entering vorticity is “rolling down the hill”), there are streamwise vortex motions at the exit plane that propel the primary flow into the ambient region. A secondary added tab provides an attachment surface that helps the vortex motions advance into the ambient region for increased entrainment.

### SUMMARY OF THE INVENTION

In one aspect of the disclosure, a compartment cooling system includes a housing defining a substantially enclosed compartment, a flow of heated gas, a nozzle, and multiple tabs. The housing has an air inlet and an air outlet stack defining a flow path. The nozzle directs the flow of heated gas substantially in the flow path direction. The nozzle has an outlet end with a predefined shape. The multiple tabs are adjacent to and spaced about the outlet end. Each tab has a side adjacent the outlet end, and at least three sides in the flow of heated gas. The sides in the flow of heated gas form at least two corners.

In another aspect of the disclosure, an engine compartment cooling system includes a housing defining a substantially enclosed compartment, an engine disposed in the compartment, an engine exhaust system, and multiple tabs. The housing includes an air inlet and an air outlet stack defining a flow path direction. The engine exhausts a flow of heated gas. The engine exhaust system includes a nozzle for directing the flow of heated gas substantially in the flow path direction. The nozzle has an outlet end with a predefined shape. Each tab has a side adjacent the outlet end, and at least three sides in the flow of heated gas. The sides in the flow of heated gas form at least two corners.

In another aspect of the disclosure, a machine compartment cooling system includes a machine body substantially defining an enclosed compartment, an engine disposed in the compartment, an engine exhaust system, and multiple tabs. The machine body includes a compartment air inlet and a compartment air outlet stack defining a flow path direction. The engine powers the machine and exhausts a flow of heated gas. The engine exhaust system includes a nozzle for directing the flow of heated gas substantially in the flow path direction. The nozzle has an outlet end with a predefined shape. Each tab has a side adjacent the outlet end, and at least three sides in the flow of heated gas. The sides in the flow of heated gas form at least two corners.

In another aspect of the disclosure, a method of cooling a compartment is disclosed. A housing substantially encloses and defines the compartment. The housing includes an air inlet and an air outlet stack defining a flow path. The compartment substantially encloses a heat radiating component. The method includes directing a flow of heated gas into the compartment substantially in the flow path direction through a nozzle with an outlet end having a predefined shape; directing the flow of heated gas over at least three sides and at least two corners formed by the three sides of each of multiple tabs, the tabs adjacent to and spaced about the outlet end; drawing air cooler than the flow of heated gas into the compartment through the air inlet; transferring heat radiating from the heat radiating component to the cooler air; and creating vortex flow between the heated gas and the cooler air with the tabs to draw the cooler air through the compartment and out of the compartment through the air outlet stack.

(Note: In fluid dynamics, turbulence or turbulent flow is a flow regime characterized by chaotic and irregular motions, which may include many eddies of different scales. A vortex (plural: vortices) means a spinning or swirling flow of fluid. Although vortex can create turbulence, people typically consider vortex as large scale and identifiable swirling flow).

### BRIEF DESCRIPTION OF THE DRAWINGS

FIG. 1 depicts an exemplary machine including an embodiment of a compartment cooling system.

FIG. 2 schematically depicts an exemplary compartment cooling system.

FIG. 3 depicts a portion of an exemplary nozzle from a perspective.

FIG. 4 depicts a portion of the exemplary nozzle of FIG. 3 from another perspective.

FIG. 5 depicts an embodiment of an exemplary tab.

FIG. 6 depicts an embodiment of an exemplary tab assembly.

FIG. 7 depicts another embodiment of an exemplary tab.

FIG. 8 depicts another embodiment of an exemplary tab assembly.

FIG. 9 schematically depicts an embodiment of a nozzle and an outlet stack with a cross section illustrating vortices.

FIG. 10 schematically depicts vortices in a cross section of the embodiment of the nozzle and the outlet stack of FIG. 9.

FIG. 11 depicts a flow chart of an exemplary cooling method.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

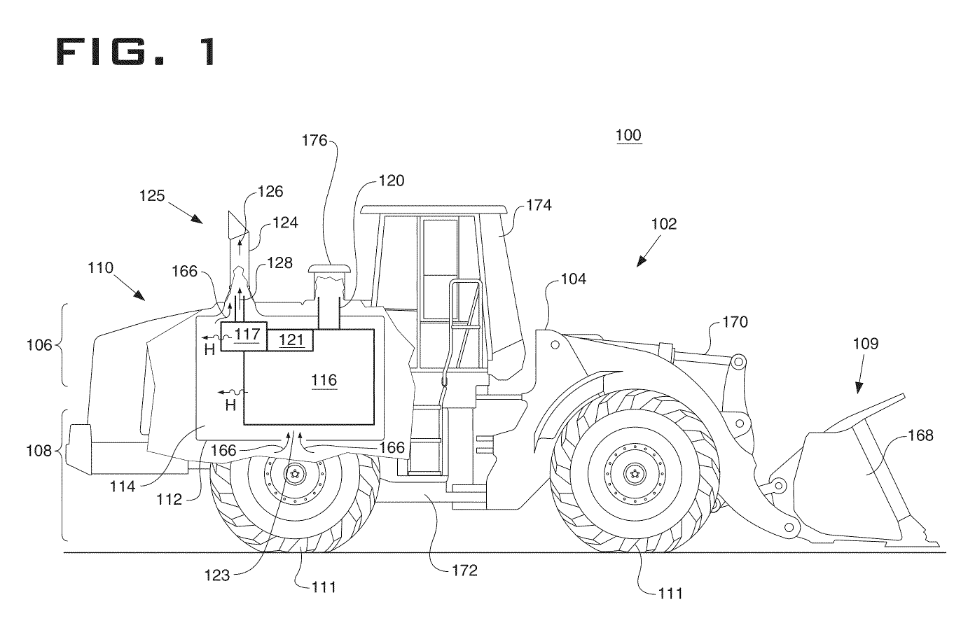

Referring now to FIG. 1, an exemplary machine 100 is illustrated. In the embodiment depicted, the machine 100 is a vehicle 102, and in particular a wheel loader 104. In some embodiments, the vehicle 104 may perform some type of operation associated with a particular industry such as mining, construction, farming, transportation, etc. and operates between or within work environments (e.g. construction site, mine site, power plants, on-highway applications, marine applications, etc.). Non-limiting examples of vehicle 104 include cranes, earthmoving vehicles, mining vehicles, backhoes, excavators, material handling equipment, dredgers, and farming equipment. In other embodiments, machine 100 may include a stationary machine, such as an electric power generator or a pumping station for oil or gas (not shown).

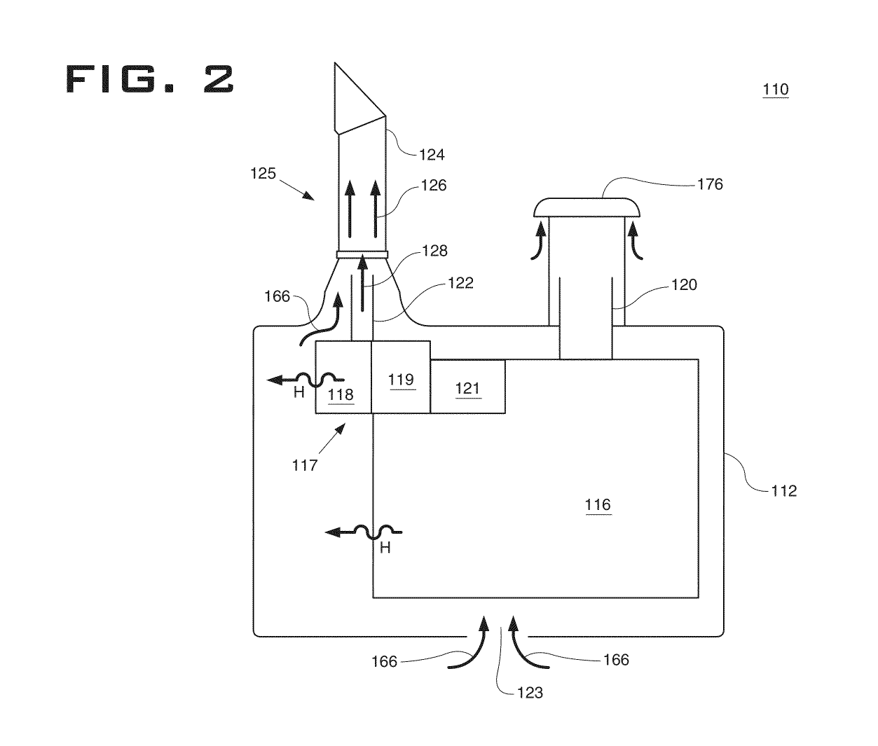

The wheel loader 104 is equipped with systems that facilitate the operation of the wheel loader 104 at a worksite. In the illustrated embodiment, these systems include a work implement system 109, a drive system 108, and a power system 106 that provides power to the work implement system 109 and the drive system 106. The drive system 108 propels the wheel loader 104 on ground engaging devices 111 (depicted as wheels) to move the wheel loader 104 from one location to another. The work implement system 109 includes at least one work implement 168 (depicted as a bucket) and actuators 170 (depicted as a hydraulic cylinder assemblies) to move the work implement 168 to perform work at the worksite. The power system 106 includes an engine 116. The engine 116 may include an internal combustion reciprocating engine, a turbine, a combination engine/generator, a fuel cell or any other engine known in the art. The wheel loader 104 includes a body 172 and a cab 174 providing a place for an operator to control the wheel loader 104 from. The body 172 defines a substantially enclosed compartment 114, a compartment gas inlet 123 and a gas outlet 125. Wheel loader 104 includes an embodiment of a cooling system 110, depicted in FIG. 2.

Referring now to FIG. 2, an exemplary embodiment of the compartment cooling system 110 is depicted The cooling system 110 includes a housing 112 (a portion of the body 172 in the embodiment of FIG. 1) defining a compartment 114 and including the gas inlet 123 and the gas outlet 125, and a nozzle 122 with a nozzle outlet 130. The gas outlet 125 defines a flow path 126. The nozzle 122 is configured to exhaust a first gas substantially in the flow path 126 direction

The illustrated embodiment includes an engine 116 disposed in the compartment 114 and exhausting a flow of a first gas 128 through the nozzle 122. The flow of the first gas may include a flow of heated gas. Although engine 116 exhausts the flow of the first gas 128 in the illustrated embodiment, in other embodiments the flow of the first gas 128 may originate and be directed through the nozzle 122 by other devices or processes known in the art. For example, a turbine may exhaust the flow of the first gas 128 into the nozzle 122, or a manufacturing process may create heat and a series of fans, air conduits, and/or valves may direct the flow of the first gas 128 through the nozzle 122.

Although engine 116 is depicted disposed in the compartment 114, in other embodiments, engine 116 may be located outside the compartment 114. In an embodiment where engine 116 includes an internal combustion engine, the flow of the first gas includes a stream of exhaust from the engine 116. In the embodiment illustrated, the engine 116 includes an air intake 120 fluidly connecting the engine 116 to air outside the compartment 114. The air intake 120 includes an air cleaner 176.

In the illustrated embodiment, the engine 116 includes an exhaust outlet 121. An exhaust system 117 is fluidly connected to the exhaust outlet 121. The exhaust system 117 includes aftertreatment 118, and a muffler 119. The nozzle 122 is fluidly connected to the exhaust outlet 121 to flow exhaust gas substantially in the flow path 126 direction. In the embodiment depicted, exhaust gas flows from the exhaust outlet 121, through the exhaust system 117, through the nozzle 122, and into the compartment 114 through the nozzle outlet 130. Some embodiments may not include the aftertreatment 118 and/or the muffler 119.

When engine 116 is running, engine 116, aftertreatment 118, and muffler 119 may transfer heat into the compartment 114 through convection as shown by the arrows marked “H”. In other embodiments, the compartment 114 may enclose other components. Exemplary non-limiting components include hydraulic pumps, transmissions, gear boxes, and hydraulic valves. Some, none, or all, of these other components may also transfer heat into the compartment 114 through convection.

Gas inlet 123 and gas outlet 125 fluidly connect the compartment 114 with gas outside the compartment 114. Gas outlet 125 defines a flow path 126 for gases to flow out of compartment 114. A second gas may enter compartment 114 through air inlet 123, flow through the compartment 114, and flow out of the compartment 114 through exhaust stack 124 via flow path 126. Arrows labeled 166 depict a flow of the second gas into and through the compartment 114. In some embodiments, the second gas includes ambient temperature air from outside the compartment 114. In most circumstances, the second gas will be cooler than the first gas. Heat may be transferred by convection from the engine 116, aftertreatment 118, and/or other components disposed in the compartment 114 to the second gas and be dispersed outside the compartment 114 as gases flow out exhaust stack 124.

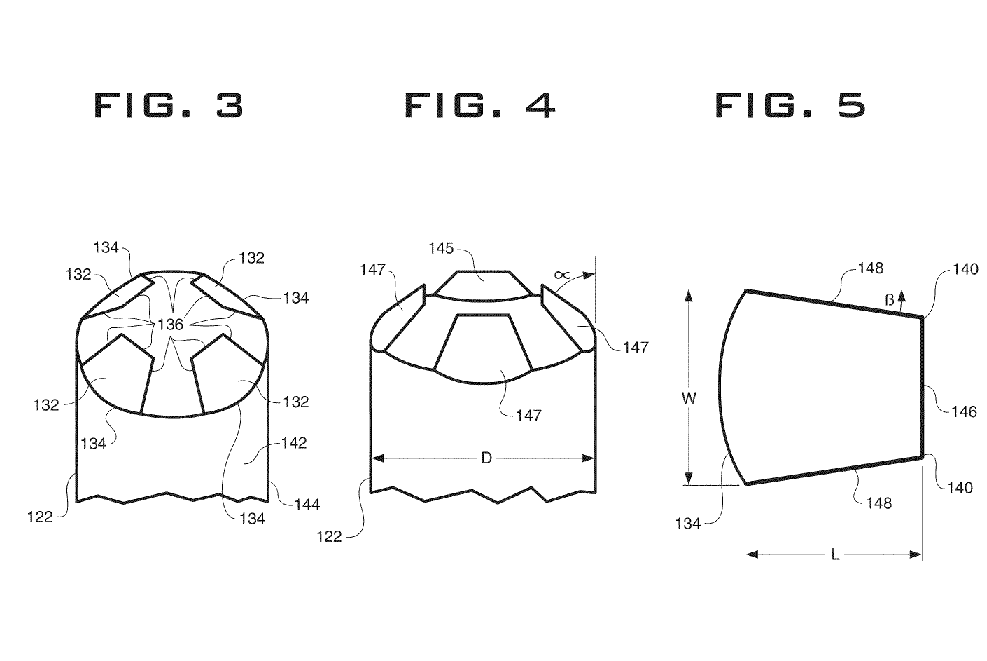

Referring now to FIGS. 3-5, two perspective views of a portion of an exemplary embodiment of the nozzle 122 having tabs 132 and an exemplary tab 132 are illustrated. Nozzle 122 includes outlet end 130 in a predefined shape. In the embodiment illustrated, the predefined shape includes a circle, and the outlet end 130 has a diameter marked as “D” in FIG. 4. In other embodiments the predefined shape may include other shapes, for example an ellipse, an octagon, a square, or any other shape that would be known by an ordinary person skilled now or in the future to be operable to direct the flow of heated gas 128 substantially in the flow path direction.

The nozzle 122 includes a nozzle body 142 having a nozzle side wall 144. In the illustrated embodiment, the nozzle body 142 is substantially cylindrical. In alternative embodiments, the body 142 may be any elongated tube type shape known in the art to be operable to direct the flow of heated gas 128 in the flow path 126 direction. Non-limiting examples include a tube like structure with cross sections in the shapes of ellipses or polygons such as octagons, or rectangles. In some embodiments, the body 142 may include cross sections which differ in shape and size at different points on the body 142. The body 142 may, for example, include a venturi type shape. At least a portion of the side wall 144 interfaces with the air in compartment 114 near the outlet end 130.

Multiple tabs 132 are adjacent to and spaced around the outlet end 130. In the illustrated embodiment, the tabs 132 are circumferentially spaced around the circular outlet end 130. Each tab 132 includes an adjacent side 134 adjacent the outlet end 130 of the nozzle 120, and at least three gas flow sides 136 in the flow of heated gas. The gas flow sides 136 form at least two corners 140.

In the illustrated embodiment four tabs 132 are circumferentially evenly spaced around the outlet end 130. In alternative embodiments, different numbers of tabs 132 may be evenly, or unevenly, spaced around the predefined shape of the outlet end 130. There may be, for example, as few as two tabs 132, or as many as eight tabs 132. The number of tabs 132, the shape of tabs 132, and the size of tabs 132, may be determined as a function of a number of factors. Non-limiting examples of factors to be considered include estimates of the range of velocities and temperatures of the stream of the first gas, the velocity profile of the stream of the first gas, and the range of other characteristics of the stream of the first gas. Other examples may include the size and shape of the nozzle 122 and outlet end 130, any obstacle or blockages along the path of the stream of the first gas, the size of the compartment 114, the range of the amount of heat to be convected from components in the compartment 114, the size, placement, and shape of the air inlet 123, and the size and configuration of the exhaust stack 124.

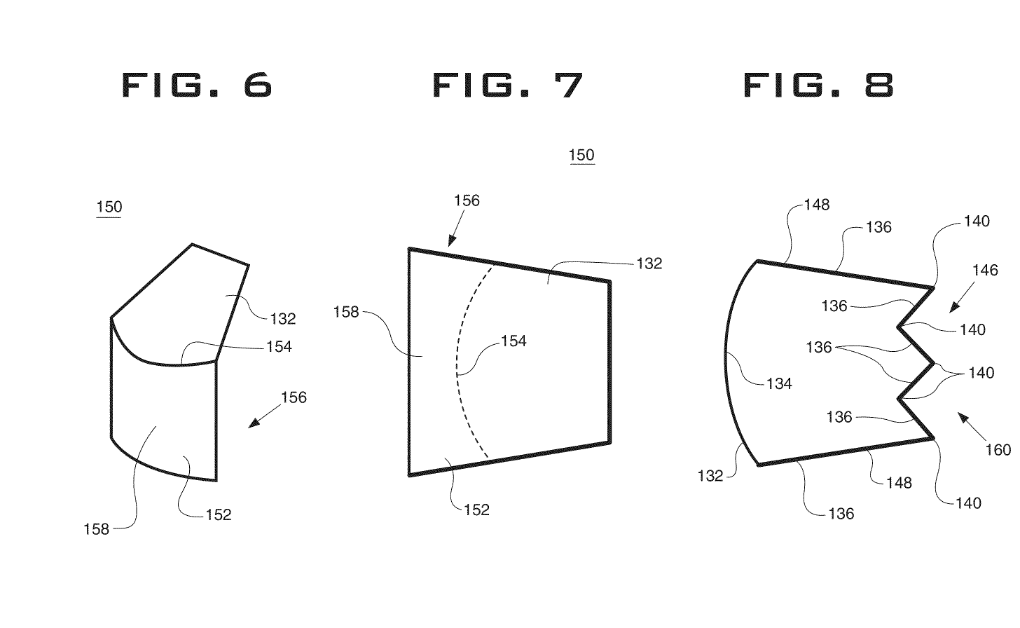

In the illustrated embodiment, the tabs 132 are fixedly attached to the nozzle 122 such that the adjacent side 134 is adjacent the outlet end 130. The tabs 132 may, for example, be welded onto the body 142 of the nozzle 122 with tab attachment pieces 152 as shown and explained in relation to FIGS. 6 and 7. In other embodiments the tabs 132 may be formed integral to the nozzle 122. In still other embodiments, the tabs 132 may be fixedly attached to the outlet end 130 with a snap ring (not shown), clamp arrangement (not shown), bolts (not shown), rivets (not shown) and/or adhesives. The tabs 132 may be fixedly attached to the nozzle 122 such that the adjacent side 134 is adjacent the outlet end 130 in any way known in the art.

It is also contemplated that in some embodiments, the tabs 132 may be fixedly attached to another component(s) different than the nozzle 122, and held stationary against the nozzle 122, such that the adjacent sides 134 are adjacent the outlet end 130. In other embodiments the tabs 132 may be fixedly attached to another component(s) different than the nozzle 122, and held in the first gas flow path. For example, the aftertreatment 118, muffler 119, and/or nozzle 122 may be at least partially enclosed by a housing (not shown). The tabs 132 may be fixedly attached to the housing by, for example, brackets, such that the adjacent sides 134 are adjacent the outlet end 130, and/or in the first gas flow.

In the embodiment illustrated, each tab 132 is a generally a trapezoidal shape with a semi-circular adjacent side 134, and three gas flow sides 136 which include an end 146 and two sides 148 of the trapezoidal shape. As depicted in FIG. 4, the outlet end includes a diameter (indicated by “D”). Each tab 136 includes a tab width (indicated by “W”), a tab length (indicated by “L”), and a trapezoid angle (indicated by “β”) as depicted in FIG. 5. In some embodiments the tab width (W) is between two tenths and five tenths of the outlet end diameter, (D), the tab length (L) is between one half to twice the tab width (W), and the trapezoidal angle (β) is between fifteen and sixty degrees. In the illustrated embodiment of FIG. 4, the side wall 144 of the nozzle 122 and the compartment surface 147 of the tab 132 define a tab-compartment air flow angle (indicated by “α”). In some embodiments, the tab-compartment air flow angle (α) is between fifteen and sixty degrees.

Tabs 132 may include a compartment surface 147 and a first gas flow surface 145. In the illustrated embodiment, each tab 132 is substantially flat, and the adjacent side 134 and gas flow sides 136 form the outline of the compartment surface 147 and the gas flow surface 145. Both the compartment surface 147 and a first gas flow surface 145 are generally planar. The compartment surface 147 may be in contact with compartment 114 air, and the gas flow surface 145 may be in contact with the flow of the first gas from the nozzle 122. In alternative embodiments, the tabs 132 may be curved as opposed to flat, and in some embodiments the tabs 132 may be angled outward in relation to the nozzle outlet 130.

In the embodiment illustrated, each tab 132 is generally the same size and shape, and adjacent the outlet end 130 at the same tab-compartment air flow angle (α). In alternative embodiments, the tabs 132 may be different shapes and sizes, and adjacent the outlet end 130 at different tab-compartment air flow angles (α).

Referring now to FIGS. 6 and 7, each figure illustrates an exemplary embodiment of a tab assembly 150. The tab assembly 150 includes one of the tabs 132 and a tab attachment piece 152 for attaching the tab 132 to the nozzle 122. The tab attachment piece 152 includes a tab edge 154, an outer side 158, and a gas flow surface 145. The tab edge 154 of the tab attachment piece 152 is fixedly attached to the adjacent side 134 of the tab 132. In one embodiment, the tab 132 and the tab attachment piece 152 may be formed as one integral piece through molding or from bending and shaping sheet metal. In other embodiments, the tab 132 and the tab attachment piece 152 may be welded together, riveted together, bolted together or fixedly attached together by any means known in the art.

The tab assembly 150 may be fixedly attached to the nozzle 122 by fixedly attaching the nozzle side 156 of the tab attachment piece 152 to the nozzle side wall 144 of the nozzle 122 such that the adjacent side 134 of the tab 132 is adjacent the outlet end 130 of the nozzle 122. The nozzle side 156 may be fixedly attached to the nozzle side wall 144 through welding, adhesive, clamps, snap rings, bolts, or any other means known in the art.

FIG. 6 illustrates a tab assembly 150 formed to be attached to the nozzle 122. FIG. 7 illustrates an embodiment a tab assembly 150 including a generally flat piece of metal. This embodiment may be bent and shaped to attach to nozzle 122.

FIG. 8 illustrates another exemplary embodiment of a tab 132. The tab 132 in FIG. 8 is similar to the embodiments of the tab 132 illustrated and described in relation to FIGS. 3-5, except that instead of three gas flow sides 136, tab 132 includes six gas flow sides 136; instead of an end 146, tab 132 includes a saw tooth end 160 with four gas flow sides 136; and instead of two corners 140, tab 132 includes five corners 140.

### INDUSTRIAL APPLICABILITY

When machine 100 is required to perform work requiring high power levels, and meet stricter exhaust emission regulations, engine 116, aftertreatment 118, and muffler 119 may operate with relatively high engine and exhaust temperatures. Engine 116, aftertreatment 118, and/or muffler 119 may also be substantially enclosed in compartment 114 to assist in meeting noise emission regulations. The second gas flow 166 necessary to effectively cool the engine 116 and/or other components in these conditions may be difficult to achieve. Directing the flow of the first gas into the compartment 114 substantially in the direction of the flow path 126, may create a pumping action which draws and increases the velocity of the flow of the cooler second gas 166 through the air inlet 123, through the compartment 114, and out the exhaust stack 124. Directing the flow of the first gas 128 through nozzle 122, and over at least three gas flow sides 136 and at least two corners 140 formed by the three gas flow sides 136 on multiple tabs 132 adjacent to and spaced about the outlet end 130 of the nozzle 122, may increase the pumping effect and the flow of the cooler second gas 166 through the compartment 114. When the flow of the first gas 128 meets the flow of the second gas at these corners, vortices may form. These vortices may increase the velocity of the flow of the second gas through the compartment 114, and thus improve cooling efficiency. Experimental results indicate, that in many circumstances, increasing the number of corners 140 on tabs 132 increases the velocity of the flow of the second gas through the compartment 114, generating a higher volume flow of the second gas through the compartment 114, and providing better cooling of components such as the engine 116, aftertreatment, 118, and muffler 119 contained in the compartment 114.

Referring now to FIG. 11 a method 200 of cooling a component substantially enclosed by a compartment 114, the compartment 114 defined by a housing 112 is illustrated in a flow chart. The compartment 114 includes a gas inlet 123 and a gas outlet 125 defining a flow path 126.

The method 200 includes directing a flow of a first gas 128 into the compartment 114 substantially in the flow path 126 direction; and directing the flow of the first gas 128 over at least three sides 136 and at least two corners 140 formed by the three sides 136 of each of multiple tabs 132. Additionally included in the method 200 is drawing a second gas, cooler than the first gas, through the gas inlet 123, into and through the compartment 114, and out the gas outlet 125; and cooling the component through convection with the second gas. The method also includes creating vortices between the flow of the first gas 128 and the cooler second gas with the tabs 132 to increase the velocity of the second gas through the compartment 114 and increase the rate of convection.

The method 200 starts at step 202 and proceeds to step 204. Step 204 includes directing a flow of heated gas 128 into the compartment 114 substantially in the flow path 126 direction. In the embodiment illustrated in relation to FIGS. 1 and 2, the engine 116 produces heated exhaust gases and directs a flow of these heated gases through the engine outlet 121, aftertreatment 118, muffler 119, nozzle 122, and outlet end 130. The exhaust stack 124 defines the flow path 126. The nozzle 122 directs the exhaust gas flow substantially in the direction of the flow path 126. In alternative embodiments, the flow of heated gas may originate from other types of combustion or processes which produce heat and release the heat in the form of some type of flow of gas(es).

The method 200 proceeds from step 204 to step 206. Step 206 includes directing the flow of heated gas 128 over at least three gas flow sides 136 and at least two corners 140 formed by the gas flow sides 136 of each of multiple tabs 132. In the embodiment depicted in FIGS. 3, 4, and 9, the tabs 132 are adjacent to and spaced about the outlet end 130 of nozzle 122. In other embodiments, the tabs 132 may be spaced in other ways and secured in the flow of the first gas 128 in other ways known by ordinary persons skilled in the art.

A tab 132 may include a gas flow surface 145 and a compartment surface 147. The gas flow surface 145 may face into the flow of the first gas 128. In the embodiment depicted in FIGS. 3, 5, and 9, the gas flow surface 145 faces into the nozzle 122, The compartment surface 147 may face outwardly from the flow of the first gas 128, and/or opposite the direction of the gas flow surface 145; and into the compartment 114. In the depicted embodiment, the flow of the first gas 128 flows against and then around the gas flow surface 145, as well as through spaces between the tabs 132. As the flow of the first gas 128 flows around the gas flow surface 145 and between the tabs 132, the flow of the first gas 128 flows over at least three gas flow sides 136 and at least two corners 140 formed by the gas flow sides 136. When the adjacent sides 134 of the tabs 132 are adjacent to the outlet end 130, as depicted in FIGS. 3, 5, and 9, little if any of the flow of heated gas 128 flows over the adjacent sides 134.

The method 200 proceeds from step 206 to step 208. Step 208 includes drawing a second gas, cooler than the first gas, through the gas inlet 123, into and through the compartment 114, and out the gas outlet 125. Air inlet 123 may include an aperture in the housing such as, for example, a vent. In some embodiments the second gas may flow through a tube, or other ductwork, to the air inlet 123. In the depicted embodiment of the machine 100, where the machine body 172 defines the compartment 114, the air inlet may be an aperture at the bottom of the compartment 114. In most circumstances, the air outside the compartment 114 and/or surrounding the machine 100 will be cooler than the flow of the first gas 128 being exhausted by engine 116. The temperature differential between the exhaust gas and the ambient air entering the compartment 114 will generally increase as engine 116 operating temperature and/or load increases.

The method 200 proceeds from step 208 to step 210. Step 210 includes cooling the component through convection with the second gas. The component may include the engine 116, aftertreatment 118, muffler 119, and/or other components (not shown) such as transmissions, hydraulic valves and pumps, and other components which would be known to an ordinary person skilled in the art now or in the future. Transferring heat from components to a flow of a second gas 166 by convection is a well known cooling method in the art.

The method 200 proceeds from step 210 to 212. Step 212 includes creating vortex flow between the flow of the first gas 128 and the cooler second gas with the tabs 132 to increase the velocity of the second gas through the compartment 114 and increase the rate of convection. Increasing the velocity of a cooler second gas into a compartment 114, through the compartment 114, and out an exhaust stack 124, by directing a flow of a first gas 128 into the compartment 114, substantially in the direction of a flow path 126 defined by the exhaust stack 124, is well known in the art. In the depicted embodiment of FIGS. 1 and 2, the warmer flow of the first gas 128 rises out the exhaust stack 124 creating a draw of the cooler second gas through the compartment 114. Additional vortex flow 164 and turbulence created by the tabs 132 may enhance mixing between the first gas and the second gas which in turn increases the velocity of the flow of the cooler second gas 166 through the compartment 114. Experimentation has shown that increasing the number of corners 140 on the tabs 132 (at least to a point) in the flow of the first gas, increases the vortex flow 164 and turbulence, and in turn the velocity of the flow of the second gas 166.

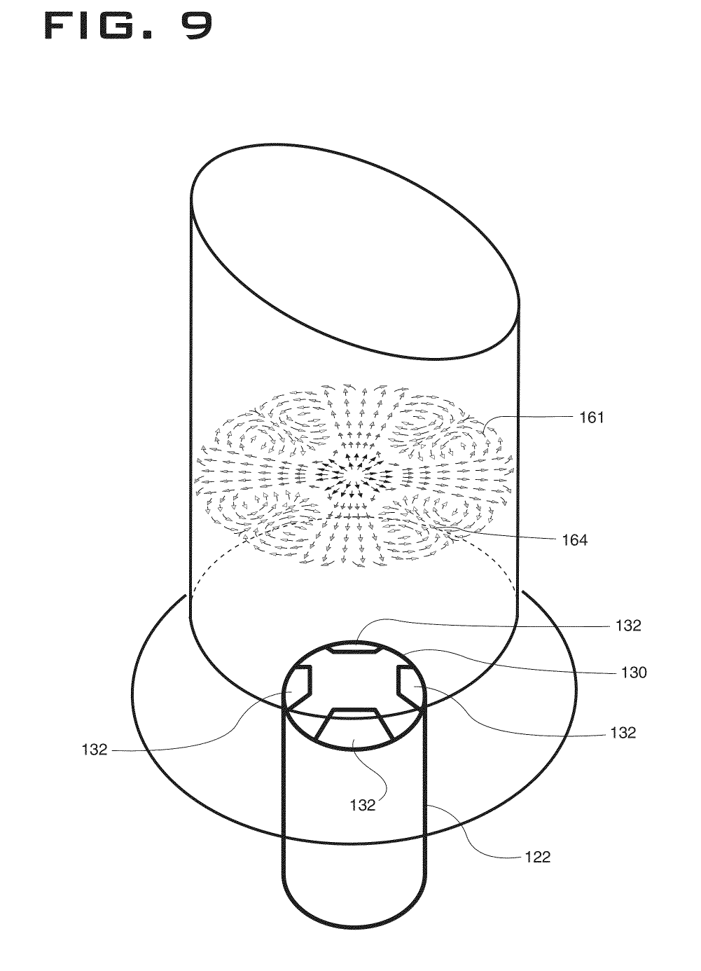

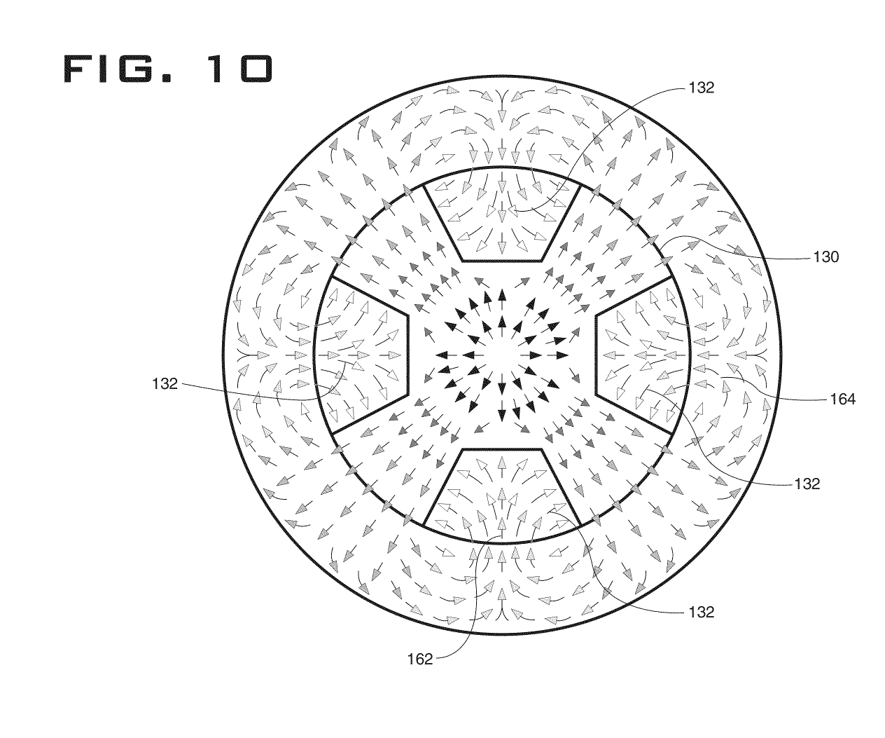

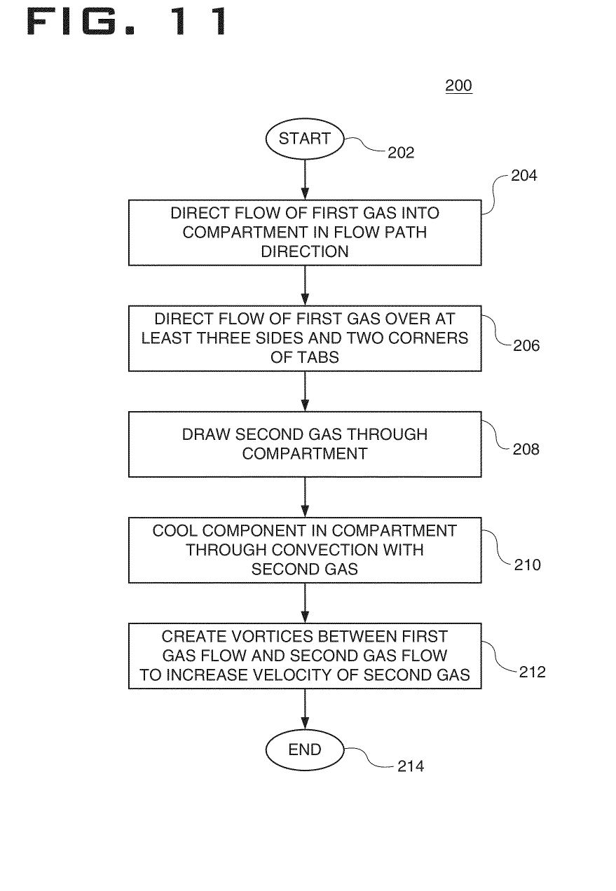

Referring now to FIGS. 9 and 10, an embodiment of a nozzle 122 and an exhaust stack 124 with a cross section 161 illustrates vortex flow 164 created by tabs 132. As described in relation to step 206, as the flow of the first gas 128 flows around the gas flow surface 145 and between the tabs 132, the flow of the first gas 128 flows over at least three gas flow sides 136 and at least two corners 140 formed by the gas flow sides 136 of each tab. The cooler flow of the second gas 166 flows around the nozzle 122 and the outlet end 130, and over the compartment surface 147 of the tabs 132. The flow of the first gas 128 meets the cooler flow of the second gas 166 at the outlet end 130 between the tabs 132, and at the gas flow edges 136 and corners 140. Vortices 162 may be formed behind the tabs as the flow of the first gas 128 and the cooler flow of the second gas 166 meets at the corners 140. An increased number of corners 140 formed by gas flow sides 136 on a tab 132 may increase the number of vortices 162, and the velocity of the flow of the cooler second gas 166 through the compartment 114. Referring back to FIG. 11, the method 200 moves from step 212 to step 214 and ends.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A cooling system, comprising:
a housing defining a compartment and including a gas inlet and a gas outlet defining a flow path,
a nozzle configured to exhaust a first gas substantially in the flow path direction, the nozzle including an outlet end with a predefined shape, the outlet end disposed in the compartment,
multiple tabs adjacent to and spaced about the outlet end, each tab having a side adjacent the outlet end, at least three sides angled inward of the outlet end, and at least two corners formed by the sides and located inward of the outlet end.

2. The cooling system of claim 1, wherein the nozzle includes a side wall and the side wall and each tab define a tab-compartment air flow angle greater than 15 degrees.

3. The cooling system of claim 1, wherein the nozzle includes a side wall and the side wall and each tab define a tab-compartment air flow angle less than 60 degrees.

4. The cooling system of claim 1, wherein at least one tab is generally trapezoidally shaped, and includes one side adjacent the outlet end and three sides inward of the outlet end defining a trapezoidal angle between 10 and 20 degrees.

5. The cooling system of claim 1, wherein the multiple tabs include 8 or less tabs evenly spaced about the outlet end.

6. The cooling system of claim 1, wherein the outlet end is generally circular.

7. The cooling system of claim 6, wherein the outlet end includes an outlet end diameter, at least one tab includes a tab width, and the tab width is between two tenths and five tenths of the outlet end diameter.

8. The cooling system of claim 1, wherein at least one tab includes a tab width and a tab length, and the tab length is between one half to twice the tab width.

9. The cooling system of claim 1, wherein at least one of the tabs is welded onto the nozzle.

10. The cooling system of claim 1, wherein at least one of the tabs is integral with the nozzle.

11. The cooling system of claim 1,
further comprising a tab assembly including one of the tabs and a tab attachment piece for attaching the tab to the nozzle, the tab attachment piece including a tab edge and a nozzle side, and
wherein the tab edge is attached to the side of the tab adjacent the outlet end, and the nozzle side is attached to the nozzle.

12. The cooling system of claim 1, wherein at least one of the tabs includes six sides in the flow of heated gas, and five corners formed by the sides in the flow of heated gas.

13. The cooling system of claim 1, further including a combustion power source with an exhaust outlet, the exhaust outlet fluidly connected to the nozzle.

14. The cooling system of claim 13, wherein the combustion power source includes an internal combustion engine at least partially disposed in the compartment.

15. The cooling system of claim 13, further comprising an exhaust aftertreatment system in fluid communication with the exhaust outlet and the nozzle, and at least partially disposed in the compartment.

16. A cooling system, comprising:
a housing defining a compartment and including an gas inlet and an gas outlet defining a flow path,
an engine including a exhaust outlet,
a nozzle fluidly connected with the exhaust outlet and configured to direct exhaust from the engine in the flow path direction, the nozzle including an outlet end with a predefined shape, the outlet end disposed in the compartment,
an engine exhaust aftertreatment system at least partially disposed in the compartment, the aftertreatment system fluidly connected with the nozzle and the exhaust outlet,
multiple tabs adjacent to and spaced about the outlet end, each tab having a side adjacent the outlet end, at least three sides angled inward of the outlet end, and at least two corners formed by the sides and located inward of the outlet end.

17. A machine cooling system, comprising:
a machine body defining a substantially enclosed compartment and including a compartment gas inlet and a compartment gas outlet defining a flow path through the compartment,
an engine powering the machine including an exhaust outlet,
a nozzle fluidly connected with the exhaust outlet and configured to direct exhaust from the engine in the flow path direction, the nozzle including an outlet end with a predefined shape, the outlet end disposed in the compartment,
an engine exhaust aftertreatment system at least partially disposed in the compartment, the aftertreatment system fluidly connected with the nozzle and the exhaust outlet,
multiple tabs adjacent to and spaced about the outlet end, each tab having a side adjacent the outlet end, at least three sides gas angled inward of the outlet end, and at least two corners formed by the sides gas and located inward of the outlet end.

18. A method of cooling a component substantially enclosed by a compartment, the compartment defined by a housing and including a gas inlet and a gas outlet defining a flow path, comprising:
directing a flow of a first gas into the compartment substantially in the flow path direction,
directing the flow of the first gas over at least three sides and at least two corners formed by the three sides of each of multiple tabs,
drawing a second gas, cooler than the first gas, through the gas inlet, into and through the compartment, and out the gas outlet,
cooling the component through convection with the second gas, and
creating vortex flow between the flow of the first gas and the flow of the cooler second gas with the tabs to increase the velocity of the flow of the second gas through the compartment and increase the rate of convection.

19. The method of claim 18, wherein the flow of the first gas is directed into the compartment through a nozzle.

20. The method of claim 18 wherein the nozzle includes an outlet end having a predefined shape and the tabs are adjacent to and spaced about the outlet end.

21. The method of claim 18, wherein the flow of the first gas includes exhaust gas from an engine disposed in the compartment.

22. The method of claim 18, wherein the component includes one of an engine, an aftertreatment system, and a muffler.
